(19) United States
(12) Patent Application Publication
(10) Pub. No.: US 2012/0217196 A1
(43) Pub. Date: Aug. 30, 2012

(54) Exchangeable Filter Element, Filter Part Fixed with Respect to System, and Filter System

(75) Inventors: Yihao Zhu, Ludwigsburg (DE); Florentin Van Uffelen, Ludwigsburg (DE)

(73) Assignee: MANN+HUMMEL GMBH, Ludwigsburg (DE)

(21) Appl. No.: 13/505,893

(22) PCT Filed: Oct. 12, 2010
(86) PCT No.: PCT/EP2010/065244

§ 371 Date: May 3, 2012

(30) Foreign Application Priority Data
Nov. 3, 2009 (DE) 10 2009 051 696.4

(51) Int. Cl. B01D 27/08; B01D 35/153

(52) U.S. Cl. 210/232

(57) ABSTRACT

The invention describes an exchangeable filter element (14) for upright installation in a filter system (10) for liquids, in particular oil, fuel or water, in particular of a motor vehicle, a receptacle (18), which is fixed with respect to the system, of the filter system (10), and the filter system (10). The exchangeable filter element (14) comprises a filter housing (46) with an end wall (50, 52) to which a central connecting piece (16) is fastened. An encircling annular seal (90) is designed such that, when the exchangeable filter element (14) is installed, said annular seal closes off an aeration and/or deaeration duct (44) of the receptacle (18), which is fixed with respect to the system, for the connecting piece (16).

### TECHNICAL FIELD

The invention concerns an exchangeable filter element for upright installation in a filter system for liquids, especially oil, fuel or water, especially of a motor vehicle, comprising a filter housing with an end face on which a central connecting socket is attached.

Moreover, the invention concerns a system-fast filter part of a filter system for liquids, especially oil, fuel or water, especially of a motor vehicle, with which an exchangeable filter element in upright position is connectable, comprising an inlet for the liquid to be purified and an outlet for the purified liquid, wherein the system-fast filter part has a receptacle in which a connecting socket of the exchangeable filter element can be installed.

Moreover, the invention concerns a filter system for liquids, especially for oil, fuel or water, especially of a motor vehicle, comprising a system-fast filter part with an inlet for the liquid to be purified and an outlet for the purified liquid, and an exchangeable filter element that is installed exchangeably in a receptacle of the system-fast filter part.

### PRIOR ART

In the oil circuit of commercial motor vehicle engines, oil filters with an exchangeable filter element are used wherein the exchangeable filter element is to be exchanged in certain maintenance intervals. In the so-called upright installation, the exchangeable filter element is inserted from above or removed upwardly in the direction of the force of gravity in a being called system-fast filter head. The filter housing of the exchangeable filter element has for this purpose a lower end face, in the direction of the force of gravity, with a central connecting socket that is inserted in the mounted state into a receptacle of the filter head. The filter head comprises an inlet and an outlet for the oil that is being passed through the exchangeable filter element. Upon removal of the used exchangeable filter element that is still filled with oil, oil can escape from an area between the end face of the exchangeable filter element and the receptacle of the filter head and can soil the engine compartment.

The invention has the object to further develop an exchangeable filter element, a system-fast filter part, in particular a filter head, and a filter system of the aforementioned kind in such a way that an escape of liquid, in particular when removing the used exchangeable filter element, is avoided in a simple way.

### SUMMARY OF THE INVENTION

This object is solved in accordance with the invention in that a circumferentially extending annular seal is designed such that, when the exchangeable filter element is installed, it closes a venting and/or exhausting channel of a system-fast receptacle for the connecting socket.

The exchangeable filter element according to the invention serves for purifying liquids, such as oil, water or fuel. In particular, the liquid filter is provided for purifying lubricant oil of an internal combustion engine. The exchangeable filter element can however also be used for purifying water in other types of water-containing closed or open systems, for example, drinking water systems, process water systems, heating water systems, cooling water systems or boiler water systems. The exchangeable filter element is mounted as a unit on a correspondingly designed system-fast filter part. In case of filter exchange, the exchangeable filter element is removed as a unit and is replaced with a new exchangeable filter element. The exchangeable filter element according to the invention is especially advantageous in case of a substantially upright installation position, i.e., with downwardly oriented openings in the filter housing, because soiling of the environment by escaping liquid is largely prevented. According to the invention, when removing the exchangeable filter element, the annular seal prevents the escape of liquid in the area of the connecting location between the connecting socket and the end face of the filter housing. The used liquid collected in the interior of the filter housing can drain only through the connecting socket. However, this is possibly only once the exchangeable filter element has been removed so far from the receptacle of the system-fast filter part that the corresponding drain control of the system-fast filter part is opened. The used liquid that exits in this state from the exchangeable filter element is completely caught by the drain control. A lateral escape of liquid and soiling of the environment, in particular of a motor compartment, are reliably prevented. The venting and/or exhausting channel during this installation and removal process opens so that an interior of the receptacle is vented or exhausted and a pressure compensation to the environment takes place. Upon installation of the connecting socket, the air that is present in the interior of the receptacle that serves for receiving the connecting socket is displaced by the connecting socket and is discharged through the venting and/or exhausting channel. Upon removal, environmental air is correspondingly supplied through the venting and/or exhausting channel into the interior. The pressure compensation serves also for preventing escape of used liquid into the environment. In the final installation position of the exchangeable filter element, the venting and/or exhausting channel is automatically seal-tightly closed relative to the interior by the annular seal.

In an advantageous embodiment, a circumferentially extending seal ring with a contact surface can be arranged on the end face. The contact surface of the seal ring in the mounted state can seal-tightly rest on a sealing surface of the system-fast filter part.

In a further advantageous embodiment, the annular seal can be a sealing lip that is formed monolithically on the seal ring radial inwardly of its contact surface. In this way, the component expenditure, the manufacturing expenditure, and the mounting expenditure are reduced.

In a further advantageous embodiment, the annular seal can be movable at least axially relative to the connecting socket, in particular for installation and removal of the exchangeable filter element. This is advantageous in particular when using a connecting socket which, upon installation and removal of the exchangeable filter element, is movable relative to the end face of the filter housing. With such a movable connecting socket, tolerances during installation can be compensated so that there is always a sufficient contact pressure for the sealing action.

Advantageously, the central connecting socket can be locked by means of locking tabs or snap-on walls in a central opening of the end face wherein the locking tabs or snap-on walls are completely covered by the annular seal. The individual locking tabs or snap-on walls are separated from each other by fluid-permeable free areas. However, since the latter are surrounded completely by the annular seal, an undesirable escape of liquid is reliably prevented here. At the same time, a simple and efficient mounting action as well as secure holding of the connecting socket on the filter housing are enabled.

The connecting socket and the end face can be connected advantageously also seal-tightly with each other and the annular seal can be a separate component, in particular an O-ring. A separate seal between the connecting socket and the end face is then not required. The annular seal serves then substantially for closing off the venting and/or exhausting channel.

In a further advantageous embodiment, the annular seal can rest at least partially in radial direction seal-tightly on a socket seal surface of the connecting socket. In this way, the annular seal can seal additionally the connecting socket relative to the interior of the receptacle.

The socket seal surface can advantageously be a circumferentially extending circumferential surface of the connecting socket. Preferably, the socket seal surface has a cylindrical shape. In this way, the annular seal upon insertion and removal of the connecting socket in axial direction into or from the preferably cylindrical receptacle of the system-fast filter part can rest flat on the socket seal surface and on an appropriate inner surface of the receptacle. In this way, the contact of the annular seal in the receptacle is improved.

In a further advantageous embodiment, when the exchangeable filter element is mounted, an opening of the venting and/or exhausting channel to an interior of the receptacle may be spatially higher than a drain opening of the interior for the liquid. In this way, it is ensured that the liquid that collects at the bottom in the interior can only drain through the drain opening. No liquid can pass into the venting and/or exhausting channel.

In a further advantageous embodiment, the annular seal can be comprised of material that at temperature of use is substantially rigid, in particular a thermoplastic material. Rigid annular seals can be produced simpler and more cost-efficient than elastic annular seals. Moreover, the rigid annular seal can assume additional guiding functions during installation or removal of the exchangeable filter element. The use of a rigid annular seal reduces moreover the risk that the exchangeable filter element is mounted wrongly and the annular seal is thereby pinched and impaired in its function. Thermoplastic materials are inexpensive materials and can be softened simply at higher temperatures without chemical change and brought into the desired shape.

The object is further solved according to the invention by the system-fast filter part in which the receptacle has a venting and/or exhausting channel that extends at least axially to the receptacle, is at least section-wise open toward an interior of the receptacle, and can be closed off by means of a circumferentially extending annular seal, in particular of an exchangeable filter element according to the invention, relative to the interior of the receptacle. The venting and/or exhausting channel enables during installation and during removal of the connecting socket a pressure compensation of the interior of the receptacle relative to the environment. In this way, liquid that is contained within the interior of the receptacle, can be drained optimally in particular by means of a corresponding drain control of the system-fast filter part. This prevents escape of liquid into the environment. In the final installation position of the exchangeable filter element, the annular seal closes off the venting and/or exhausting channel seal-tightly so that no liquid can escape into the environment.

Moreover, the object is solved according to the invention by a filter system in which an exchangeable filter element according to the invention is connected to a system-fast filter part according to the invention. The advantages that are listed above in connection with the exchangeable filter element according to the invention and the system-fast filter part according to the invention apply likewise to the filter system.

### BRIEF DESCRIPTION OF THE DRAWINGS

Further advantages, features, and details of the invention can be taken from the following description in which embodiments of the invention are explained in more detail with the aid of the drawing. A person of skill in the art will expediently consider the features disclosed in combination in the drawing, the description, and the claims also individually and combine them to meaningful further combinations. It is show in:

FIG. 1 schematically a detail of a filter system for liquids in accordance with a first embodiment in half-section;

FIG. 2 schematically a filter head of the filter system of FIG. 1 in half-section;

FIG. 3 schematically the filter head of the FIGS. 1 and 2 in plan view;

FIG. 4 schematically in isometric illustration a detail of a filter system for liquids according to a second embodiment, which is similar to the first embodiment, in half-section.

In the Figures, the same components are identified with same reference characters.

### EMBODIMENT(S) OF THE INVENTION

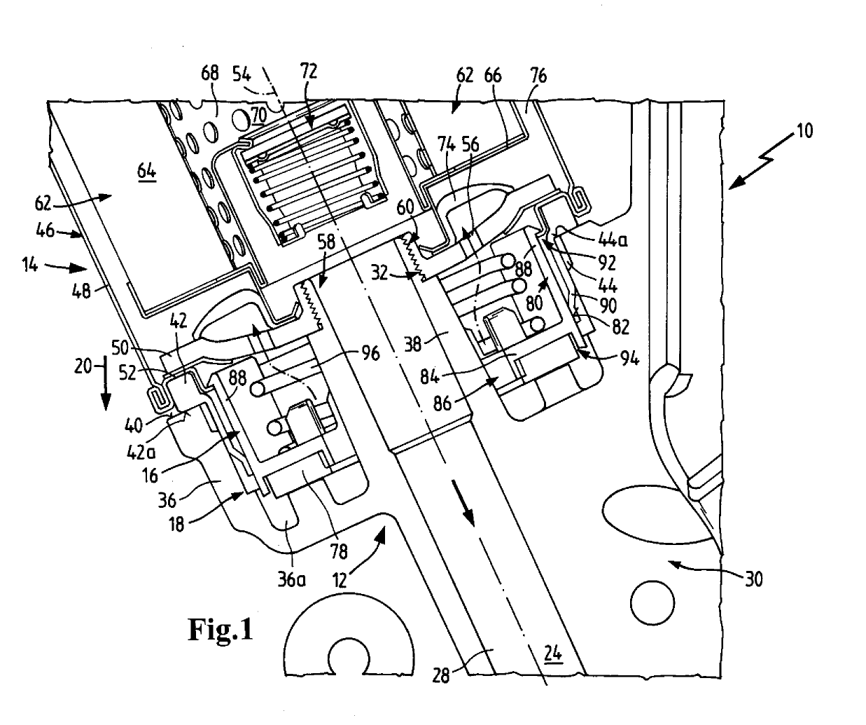

In FIG. 1, a detail of a filter system 10 for liquids in accordance with a first embodiment is illustrated in half-section.

The filter system 10 is used for filtering motor oil in the oil circuit of an internal combustion engine of a motor vehicle.

The filter system 10 comprises a system-fast filter head 12 and an exchangeable filter element 14 that is inserted exchangeably with a connecting socket 16 into a receptacle of the filter head 12.

The exchangeable filter element 14 is provided for upright installation. Upright installation means also a slightly slanted installation as illustrated in FIG. 1. The force of weight acting in the usual mounting position is indicated by an arrow 20. Accordingly, the connecting socket 16 is at the bottom in the provided installation position relative to the force of weight.

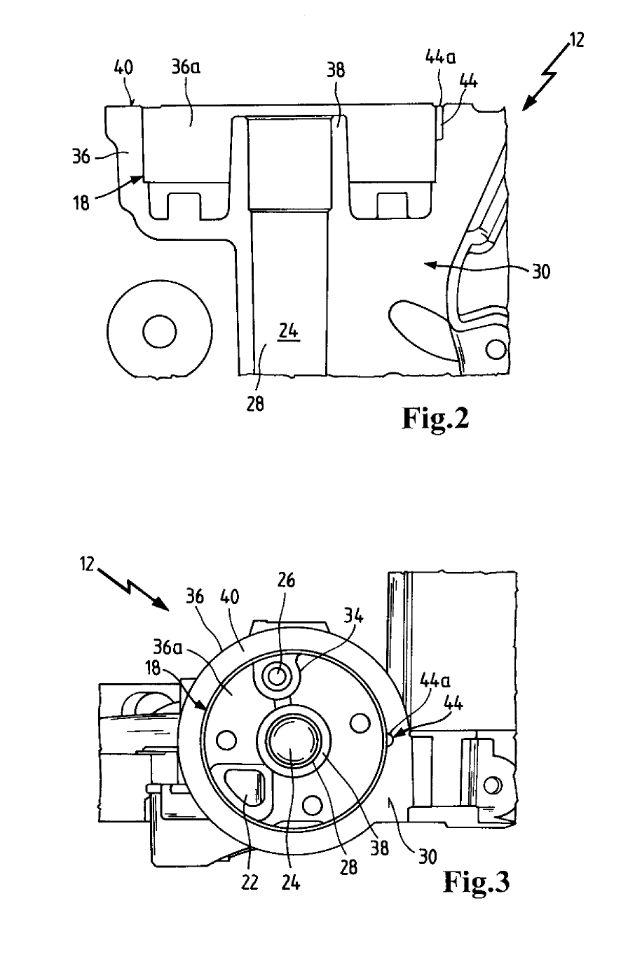

The filter head 12 is illustrated in FIGS. 2 and 3 in detail. The filter head 132 has an inlet 22 illustrated in FIG. 3 for the motor oil to be purified, an outlet 24 for the purified motor oil, as well as a drain bore 26 illustrated in FIG. 3.

The outlet 24 is formed as a multi-step tube 28 that is integrated into a base part 30 of the filter head 12. In the area of its free end that is facing the exchangeable filter element 14, the tube 28 has an outer thread 32. In FIG. 2, the section of the tube 28 with the outer thread 32 is not illustrated to simplify the illustration.

The drain bore 26 is arranged in a boss shown in FIG. 3. The boss projects in axial direction past the level of the inlet 22. The tube 28 projects in axial direction past an annular collar 36 of the receptacle 18 that surrounds the inlet 22 and the drain bore 26. In the interior 36a of the annular collar 36 the tube 28 is surrounded by a cylindrical socket 38. At the end face the annular collar 36 has a sealing surface 40 on which is resting a seal ring 42 of the exchangeable filter element 14. The seal ring 42 forms the seal between the filter head 12 and the exchangeable filter element 14.

The annular collar 36 has at the upper area of its radial inner circumferential side a venting and/or exhausting channel 44 that has an opening 44a relative to the sealing surface 40 of the annular collar 36. The venting and/or exhausting channel 44 extends in a groove shape axially relative to the annular collar 36 and is open across its entire length relative to the interior 36a of the annular collar 36. When the exchangeable filter element 14 is installed, the opening 44a of the venting and/or exhausting channel 44 relative to the interior 36a is spatially higher than the drain bore 26 for the motor oil collected in the interior 36a.

The exchangeable filter element 14 comprises a filter housing 46 that is formed by a cup 48, a cover 50, and a seal holder 52. The cover 50 and the seal holder 52 form an end face of the exchangeable filter element 14. The exchangeable filter element 14 is substantially designed with rotational symmetry relative to the longitudinal axis 54. The central connecting socket 16 is attached, centrally relative to the longitudinal axis 54, radially inwardly of the seal ring 42 such on the seal holder 52 that the seal ring 42 extends circumferentially about the connecting socket 16.

The seal holder 52 is comprised of thin sheet metal which at the outer area is seal-tightly crimped to the cup 48 that is also made of sheet metal.

This seal holder 52 is designed such that it forms a seal receptacle for the seal ring 42. The seal holder 52 is non-detachably connected to the cover 50. In the cover 50 inlet openings 56 are distributed. Moreover, the cover 50 has a centrally arranged outlet 58. A cylindrical section of the cover 50 has an inner thread 60 by means of which the exchangeable filter element 14 is secured on the outer thread 32 of the tube 28 of the filter head 12.

In the interior of the exchangeable filter element 14, a filter bellows 62 is arranged. The filter bellows 62 has a folded filter medium 64 that is annularly closed and is connected seal-tightly at its end faces with upper and lower terminal disks 66. In FIG. 1, only the lower terminal disk 66 is shown.

The filter bellows 62 comprises a perforated support pipe 68 at the clean side. On the lower terminal disk 66 a closing valve 72 is arranged that extends axially into the clean side 70 surrounded by the filter bellows 62. The closing valve 72 is forced open by the volume flow of the motor oil when the exchangeable filter element 14 is in operation. When insufficient motor oil pressure is existing at the exchangeable filter element 14, the closing valve 72 closes. Accordingly, the closing valve 72 is closed also when the exchangeable filter element 14 is to be exchanged. The motor oil which is contained at the clean side in the exchangeable filter element 14 is thus prevented from draining.

Between the lower terminal disk 66 and the cover 50 a non-return membrane is arranged that forms a seal-tight connection between the cover 50 and the terminal disk 66. Moreover, the non-return membrane 74 has a membrane sealing lip which covers the inlet openings 56. As a result of the volume flow of the incoming motor oil the non-return membrane 74 is lifted off the inlet openings 56 and the motor oil to be purified can flow into the raw side 76. When no motor oil is flowing in, the non-return membrane 74 is resting seal-tightly on the cover 50 so that the motor oil that is at the raw side 76 cannot flow out through the inlet openings 56. This is advantageous because the exchangeable filter element 14 is installed in upright position, i.e., with downwardly facing inlet openings 56. Accordingly, only the minimal motor oil quantity which is located between the non-return membrane 74 and the cover 50 can drain. This motor oil quantity is however received without problem by the annular collar 36 of the filter head 12.

In order to prevent overflow of the annular collar 36 when exchanging the filter, the drain bore 26 is provided in the filter head 12. It is closed by a drain seal 78 arranged on the connecting socket 16 when the exchangeable filter element 14 is installed. Upon removal, the drain seal 78 is removed from the drain bore 26 and the motor oil can drain pressureless.

The connecting socket 16 is designed in a cup shape wherein a cylindrical circumferential wall 80 with a circumferential cylindrical socket seal surface 82 extends away from a bottom 84 that is positioned transversely to the longitudinal axis 54. In the direction toward the cover 50 of the exchangeable filter element 14, the connecting socket 16 is open. At the bottom 84, centrally to the longitudinal axis 54, an opening 86 is provided. In the area of the edge that is opposite the bottom 84 the circumferential wall 80 of the connecting socket 16 is formed, remote from the socket seal surface 82, in the form of a plurality of snap-on walls 88 that are separated from each other and distributed about the circumference.

The central opening of the seal holder 52 is delimited by a circumferentially extending edge 92. The snap-on walls 88 of the connecting socket 16 engage behind the edge 92 so that the connecting socket 16 is locked with the seal holder 52.

The seal ring 42 is designed as an axial seal whose contact surface 42a is arranged at the end face of the seal ring 42. The sealing lip 90 extending centrally about the longitudinal axis 54 is formed monolithically with the seal ring 42. It is positioned radially inwardly of the contact surface 42a and projects axially past the contact surface 42a. The sealing lip 90 is resting seal-tightly on the socket seal surface 82 of the connecting socket 16 and forms an annular seal.

The sealing lip 90 is resting in radial direction outwardly against the socket seal surface 82 of the connecting socket 16. In axial direction it covers, beginning at the seal holder 52, the snap-on walls 88 and the intermediately positioned free areas so completely that the snap-on walls 88 and the free areas as a whole are positioned on the oil-containing inner side of the filter housing 46, the seal ring 42, the sealing lip 90, and the socket seal surface 82. The monolithic molding of the sealing lip 90 on the seal ring 42 prevents that motor oil escapes from the interior of the connecting socket 16 and the seal holder 52 and in particular through the free areas between the snap-on walls 88.

When the exchangeable filter element 14 is mounted, the radial outer circumferential side of the sealing lip 90 closes off the longitudinal opening of the venting and/or exhausting channel 44 relative to the interior 36a of the annular collar 36. Moreover, the seal ring 42 closes off the opening 44a of the venting and/or exhausting channel 44 in the seal surface 40 of the annular collar 36 relative to the environment.

Upon removal of the exchangeable filter element 14, the sealing lip 90 releases the venting and/or exhausting channel 44 relative to the interior 36a of the annular collar 36 successively. At the same time, the seal ring 42 releases the opening 44a of the venting and/or exhausting channel 44 relative to the environment. Ambient air can now flow into the interior 36a of the annular collar 36 so that it is vented and a pressure compensation with the environment takes place. In this way, drainage of the motor oil through the drain bore 26 is improved.

Upon mounting of the exchangeable filter element 14, the opening 44a of the venting and/or exhausting channel 44 relative to the environment and the connection to the interior 36a of the annular collar 36 is initially open so that air from the interior 36a can be displaced into the environment. In this way, pressure compensation takes place so that the interior 36a remains pressureless. In the final installation position of the exchangeable filter element 14, the venting and/or exhausting channel 44 is automatically seal-tightly closed by the sealing lip 90 and the seal ring 42.

The drain seal 78 is arranged in a sealing groove 94 on the exterior side of the bottom 84 of the connecting socket 16, the exterior side facing away from the exchangeable filter element 14.

In order to position the drain seal 78 exactly, the connecting socket 16 is movable relative to the cover 50 in axial direction. The sealing lip 90 is movable for installation and removal of the exchangeable filter element 14 relative to the socket seal surface 82 axially relative to the connecting socket 16. Between the bottom 84 of the connecting socket 16 and the cover 50 of the exchangeable filter element 14, a spiral pressure spring 96 is arranged. The spiral pressure spring 96 generates pretension between the bottom 84 of the connecting socket 16 and the cover 50 of the exchangeable filter element 14.

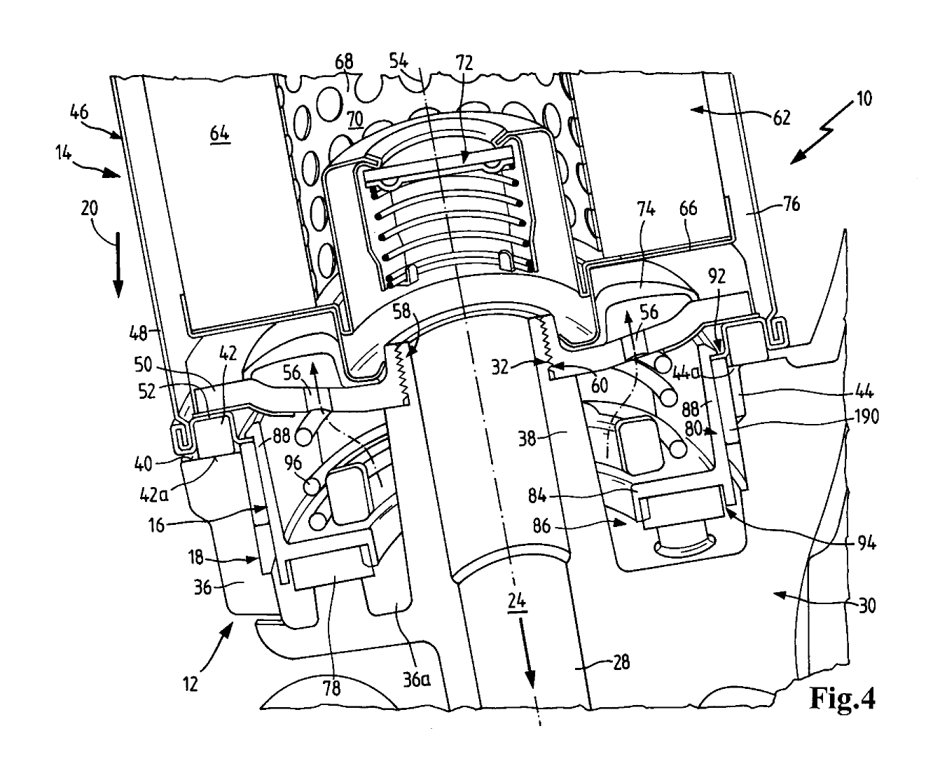

In the second embodiment, illustrated in FIG. 4, those elements that are similar to those of the first embodiment illustrated in FIGS. 1 to 3 are provided with the same reference characters so that reference is being had with regard to their description to the explanations of the first embodiment. This embodiment differs from the first one in that, instead of the sealing lip 90 being integrally formed on the seal ring 42, in the second embodiment a separate cylindrical annular seal 190 is provided. The annular seal 190 is made of thermoplastic material and is substantially rigid at temperature of use. The annular seal 190 is fastened with an end face on an annular end face surface of the seal holder 52 that adjoins its circumferentially extending edge.

In all above described embodiments of a filter system 10 for liquids, of a filter head 12, and of an exchangeable filter element 14 the following modifications are possible inter alia.

The invention is not limited to use in oil circuits of motor vehicle engines. Rather, it can also be used in different motors such as stationary internal combustion engines. The invention can also be used for purifying others types of liquids, for example, fuel or water. It can also be used in other types of water-containing closed or open systems, for example, drinking water systems, process water systems, heating water systems, cooling water systems or boiler water systems.

Instead of the filter head 12, also a different system-fast filter part, for example, a connecting flange, can be provided for connecting the exchangeable filter element 14.

As an alternative to the illustrated embodiments, deviating configurations with the same function are possible also. For example, it may be advantageous that the seal ring 42 is designed as a radial seal. The sealing lip 90 or the annular seal 190 may expediently also rest against an end face seal surface of the connecting socket 16 in axial direction. Moreover, it may be advantageous to arrange the sealing lip 90 or the annular seal 190 radially inwardly of the seal ring 42 without axial displacement relative to the contact surface.

A sealing action relative to the connecting socket 16 and thus to the socket seal surface 82 can possibly be eliminated. The sealing lip 90 and the annular seal 190 can then be designed such that it is not necessary that they rest against the connecting socket 16.

The connecting socket 16 can also be connected seal-tightly with the cover 50 and/or the seal holder 52. In this case, the snap-on walls 88 and a separate sealing action for them can be eliminated. Instead of the sealing lip 90 or the annular seal 190, a different separate annular seal, for example, an O-ring, can then be provided for closing of the venting and/or exhausting channel 44.

The exchangeable filter element 14 can be provided with a different type of filter element in place of the filter bellows 62 with the folded and annularly closed filter medium 64.

The seal holder 52, instead of being crimped, can also be connected in a different way seal-tightly with the cup 48, for example, glued or welded. The seal holder 52 and/or the cup 48 can be made of plastic material instead of sheet metal.

Instead of the spiral pressure spring 96 also a different type of tensioning means, in particular, a pressure spring, can be used for generating pretension between the bottom 84 of the connecting socket 16 and the cover 50 of the exchangeable filter element 14.

Instead of the snap-on walls 88, also a plurality of locking tabs can be provided that are separated from each other by gaps.

The connecting socket 16 can also be attached in a different way to the end face of the filter housing 46. It can also be secured in axial direction relative to the filter housing 46. The spiral pressure spring 96 can then be eliminated.

The annular seal 190 in the second embodiment can be made also of a different type of material that is rigid at the temperatures of use instead of thermoplastic material

The venting and/or exhausting channel 44, instead of being axial to the annular collar 36, can also extend at a slant thereto with an axial directional component.

The venting and/or exhausting channel 44, instead of across its entire length, can also be open only in the lower area toward the interior 36a of the annular collar 36.

Instead of the screw connection between the exchangeable filter element 14 and the filter head 12, also a different connection, in particular an insertion and/or rotation connection, can be provided.

1. Exchangeable filter element (14) for an upright installation in a filter system (10) for liquids, especially oil, fuel or water, especially of a motor vehicle, comprising
a filter housing (46) with an end face (50, 52) to which is attached a central connecting socket (16),
wherein a circumferentially extending annular seal (19; 190) closes of a venting and/or exhausting channel (44) of a system-fast receptacle (18) for the connecting socket (16) when the exchangeable filter element (14) is installed in the filter system.

2. Exchangeable filter element according to claim 1, wherein
on the end face (50, 52) a circumferentially extending seal ring (42) with a contact surface (42a) is arranged.

3. Exchangeable filter element according to claim 2, wherein
the annular seal is a sealing lip (90) that is monolithically formed on the seal ring (42) radially inwardly of its contact surface (42a).

4. Exchangeable filter element according to claim 1, wherein
the annular seal (90; 190), in particular for installation and removal of the exchangeable filter element (14), is movable at least axially relative to the connecting socket (16).

5. Exchangeable filter element according to claim 1, wherein
the central connecting socket (16) by means of locking tabs or snap-on walls (88) is locked in a central opening of the end face (50, 52),
wherein the locking tabs or snap-on walls (88) are completely covered by the annular seal (90; 190).

6. Exchangeable filter element according to claim 1, wherein
the connecting socket and the end face are seal-tightly connected to each other and the annular seal is a separate component, in particular an O-ring.

7. Exchangeable filter element according to claim 1 one of the preceding claims, wherein
the annular seal (90; 190) is resting at least section-wise in radial direction seal-tightly on a socket seal surface (82) of the connecting socket (16).

8. Exchangeable filter element according to claim 7, wherein
the socket seal surface (82) is a circumferentially extending circumferential surface of the connecting socket (16).

9. Exchangeable filter element according to claim 1, wherein,
when the exchangeable filter element (14) is installed, an opening (44a) of the venting and/or exhausting channel (44) to an interior (36a) of the receptacle (18) is spatially higher than a draining opening (26) of the interior (36a) for the liquids.

10. Exchangeable filter element according to claim 1, wherein
the annular seal (190) is of a material that is substantially rigid at temperature of use, in particular a thermoplastic material.

11. System-fast filter part (12) of a filter system (10) for liquids, especially oil, fuel or water, especially of a motor vehicle, with which an exchangeable filter element (14) in upright position is connectable, comprising
an inlet (22) for a liquid to be purified and
an outlet (24) for the purified liquid,
wherein the system-fast filter part (12) comprises
a receptacle (18) in which a connecting socket (16) of the exchangeable filter element (14) can be installed, wherein
the receptacle (18) has a venting and/or exhausting channel (44) that extends at least axially to the receptacle (18), that at least section-wise is open to an interior (36a) of the receptacle (18), and that can be closed off with a circumferentially extending annular seal (90; 190) of an exchangeable filter element (14), in particular according to claim 1, relative to an interior (36a) of the receptacle (18).

12. Filter system (10) for liquids, especially oil, fuel or water, in particular of a motor vehicle, comprising
a system-fast filter part (12) with an inlet (22) for the liquid to be purified and an outlet (24) for the purified liquid, and
an exchangeable filter element (14) that is installed exchangeably in a receptacle (18) of the system-fast filter part (12),
wherein an exchangeable filter element (14) according to claim 1 is connected to a system-fast filter part (12) comprising
an inlet (22) for a liquid to be purified and
an outlet (24) for the purified liquid,
wherein the system-fast filter part (12) comprises
a receptacle (18) in which a connecting socket (16) of the exchangeable filter element (14) can be installed,
wherein the receptacle (18) has a venting and/or exhausting channel (44) that extends at least axially to the receptacle (18), that at least section-wise is open to an interior (36a) of the receptacle (18), and that can be closed off with a circumferentially extending annular seal (90; 190) of an exchangeable filter element (14), in particular according to claim 1, relative to an interior (36a) of the receptacle (18).
